(19) United States
(12) Patent Application Publication
(10) Pub. No.: US 2011/0032386 A1
(43) Pub. Date: Feb. 10, 2011

(54) IMAGE CAPTURING SYSTEM AND SENSING MODULE

(76) Inventors: Hung-Yin Tsai, Hsinchu County (TW); Chih-Ming Kuo, Changhua County (TW)

Correspondence Address: Muncy, Geissler, Olds & Lowe, PLLC, 4000 Legato Road, Suite 310, FAIRFAX, VA, 22033, US

(21) Appl. No.: 12/851,925

(22) Filed: Aug. 6, 2010

(30) Foreign Application Priority Data
Aug. 6, 2009 (TW) 098126467

(51) Int. Cl. H04N 5/225; H04N 5/76; H04N 5/335

(52) U.S. Cl. 348/231.99; 348/340; 348/308; 348/E05.024; 348/E05.031; 348/E05.091

(57) ABSTRACT

An image capturing system and a sensing module are provided. The image capturing system includes a lens module, an image sensing element, and an adjustment element. The lens module is used for converging light of an object to an imaging surface. The image sensing element has a receiving surface for receiving the light of the object to form an image. The adjustment element is connected to the image sensing element and used for adjusting a curvature value of the receiving surface, so that the receiving surface matches the imaging surface.

### CROSS-REFERENCE TO RELATED APPLICATION

This application claims the benefit of Taiwan Patent Application No. 098126467, filed on Aug. 6, 2009, which is hereby incorporated by reference for all purposes as if fully set forth herein.

### BACKGROUND OF THE INVENTION

1. Field of Invention

The present invention relates to an image capturing system and a sensing module, and more particularly to an image capturing system and a sensing module capable of adjusting a curvature value to capture a clear image of a photographed object.

2. Related Art

With the development of technology and increasing demands of people for life quality, the development of the image capturing system has become one of an important research topic. For example, it covers digital cameras, digital camcorders, cameras for mobile phones, and security monitoring systems. A global revenue record of five billion dollars was created for an image sensor part in the image capturing system in 2008.

Generally, an image capturing system includes a lens device and an image sensing element. The image sensing element usually includes a charge-coupled device (CCD) and a complementary metal-oxide-semiconductor (CMOS), which is applied to electronic products such as digital cameras and video cameras. Due to curvature of field that exists in a common lens device, an object is imaged into a curved surface which does not conform to a light reception surface of a planar image sensing element, thereby causing blurred peripheries of the image.

The image capturing system simulates a compound eye, and an image sensing element serves as a retina and is in charge of converting an optical signal into an electrical signal. However, taking a digital camera as an example, through detailed comparison between the digital camera and human eyes, the number of lens that the digital camera needs is far larger than the number of lens that the human eyes need (generally speaking, a lens module of a digital camera usually includes more than nine sets of lenses to acquire good image quality while a human eye only needs to perform focus imaging and adjustment through a lens). The structure of the human eyes is much simpler as compared with that of the digital camera but has more powerful functions. A major reason is that in the current semiconductor technology, planar image sensors are used in the digital camera, so that a lens module having a large number of lenses needs to be used to correct the imaging surface into a plane.

In a conventional method for solving the curvature of field, the curvature of field can be reduced by using a lens device formed of different lenses through coating correction. However, due to factors such as lens combination and optical path length of the lens device, the curvature of field in the image can only be effectively reduced, instead of being completely eliminated. On the other hand, if nonplanar image sensors are adopted, the large number of lenses no longer needs to be used, so that the high fabrication cost is saved and the problem of curvature of field can be effectively solved.

In U.S. Pat. No. 4,467,361, an image capturing system is provided to solve the problem of curvature of field in an image. FIG. 1 is a schematic view of an image capturing system 9 in the prior art. As shown in FIG. 1, in the technical solution of the image capturing system 9 provided in U.S. Pat. No. 4,467,361, a light reception surface 922 of an image sensing device 92 having a specific curvature is fabricated, so that an object 5 overlaps the light reception surface 922 through an imaging surface 920 of a lens device 90, thereby eliminating the curvature of field to acquire a clear image 50.

Further, in Taiwan Patent No. 1242368, another image capturing system is provided to solve the problem of curvature of field in an image. FIG. 2 is a schematic view of an image capturing system 7 in the prior art. As shown in FIG. 2, in the technical solution of the image capturing system 7 provided in Taiwan Patent No. 1242368, a receiving surface 720 of an image transmission device 72 having a specific curvature is fabricated. An object 5 overlaps the receiving surface 720 through an imaging surface 722 of a lens device 70, the image is transmitted to an output surface 726 through an image transmission portion 724 and then received by a light reception surface 740 of an image sensing device 74, and eventually the image sensing device 74 acquires an undistorted image 50.

However, in the fabrication process of an optical element, it is very difficult to fabricate an image sensing device having a light reception surface or a receiving surface overlapping an imaging surface. Therefore, how to completely eliminate the problem of curvature of field is still under research in the academic or industrial circle currently.

### SUMMARY OF THE INVENTION

Therefore, the present invention is directed to an image capturing system, so as to eliminate the curvature of field that occurs when an image of an object is captured by adjusting a curvature value of an image sensing element.

In an embodiment of the present invention, the image capturing system includes a lens device, an image sensing element, and an adjustment element. The lens module is used for converging light of an object to an imaging surface. The image sensing element has a receiving surface for receiving the light of the object to form an image. The adjustment element is connected to the image sensing element and used for adjusting a curvature value of the receiving surface, so that the receiving surface matches the imaging surface.

The image capturing system further includes a substrate, a processing module, and a storage module. The substrate is used for carrying the image sensing element and the adjustment element. The processing module is connected to the image sensing element and used for converting the image into a telecommunication signal. In addition, the storage module is connected to the processing module and used for storing the telecommunication signal.

The present invention is further directed to a sensing module used for forming an image in cooperation with a lens module. The lens module converges light of an object to an imaging surface. The sensing module includes an image sensing element and an adjustment element. The image sensing element has a receiving surface for receiving the light of the object to form the image. In addition, the adjustment element is connected to the image sensing element and used for adjusting a curvature value of the receiving surface, so that the receiving surface matches the imaging surface.

Compared with the prior art, for the image capturing system and the sensing module in the present invention, a curvature value of the image sensing element is adjusted by using an adjustment element, so as to solve the problem of curvature of field of a common camera. In the prior art, in order to reduce the curvature of field, a set of lens modules having a large number of lenses needs to be used to correct an imaging surface into a plane or an image sensing element having a fixed curvature is used to reduce the curvature of field. The image capturing system of the present invention only needs to adjust the curvature value of the image sensing element by using the adjustment element, so that the image sensing element matches a nonplanar imaging surface of a single lens.

Therefore, the image capturing system and the sensing module in the present invention can effectively solve the problem of curvature of field that occurs in commercially available digital cameras. Moreover, compared with fabrication of a lens module of high cost, the image capturing system and the sensing module in the present invention have relatively low cost, and thus have great industrial application potential in the market of the image sensing system.

The advantages and spirits of the present invention can be further understood through the detailed description and the accompanying drawings in the following.

### BRIEF DESCRIPTION OF THE DRAWINGS

The present invention will become more fully understood from the detailed description given herein below for illustration only, and thus are not limitative of the present invention, and wherein:

FIG. 1 is a schematic view of an image capturing system in the prior art;

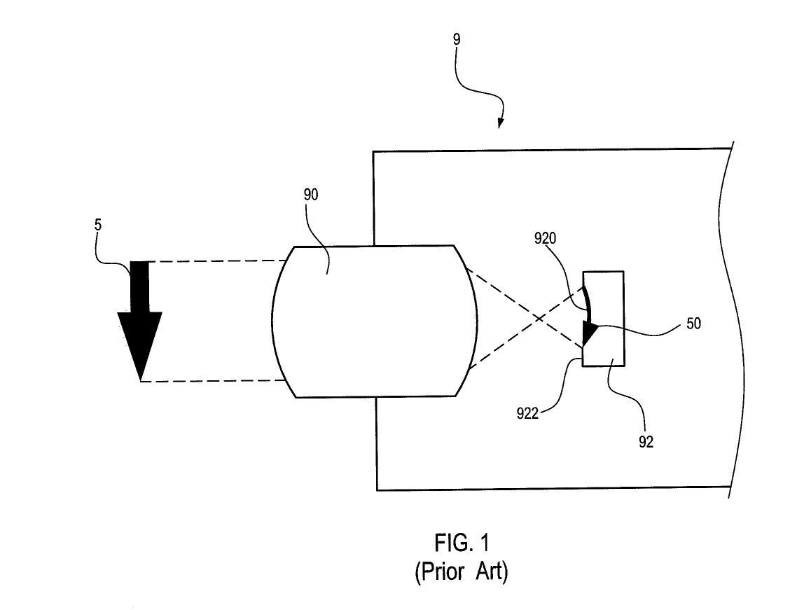

FIG. 2 is a schematic view of another image capturing system in the prior art;

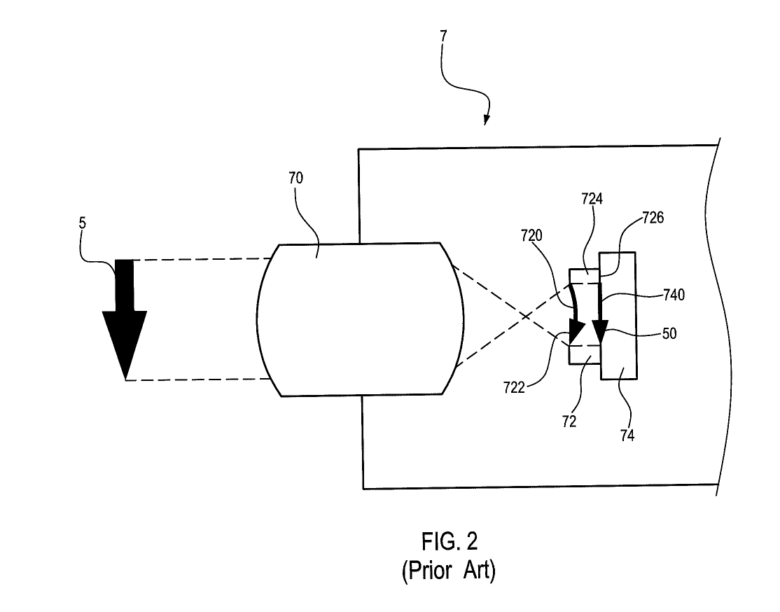

FIG. 3 is a schematic view of an image capturing system according to an embodiment of the invention; and

FIG. 4 is a schematic view of a sensing module according to an embodiment of the invention.

### DETAILED DESCRIPTION OF THE INVENTION

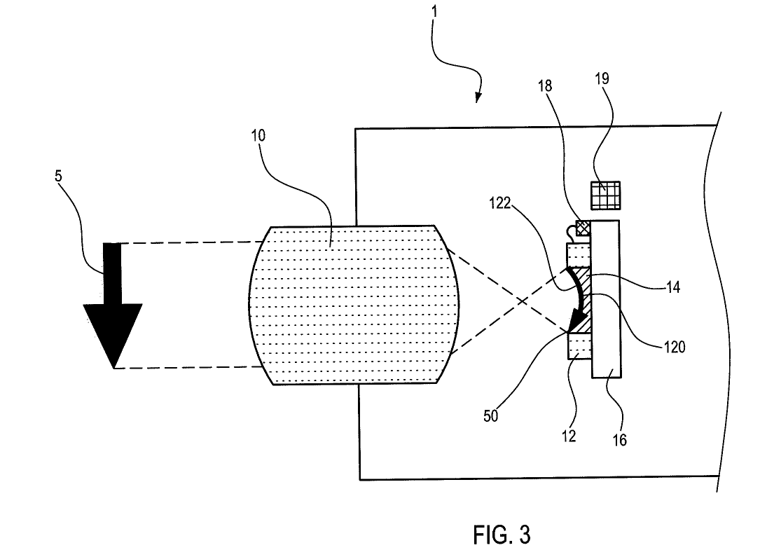

FIG. 3 is a schematic view of an image capturing system 1 according to an embodiment of the invention.

As shown in FIG. 3, the image capturing system 1 includes a lens module 10, an image sensing element 12, and an adjustment element 14. The lens module 10 is used for converging light of an object 5 to an imaging surface 122. In practical applications, the lens module 10 includes at least a lens (not shown). The lens may be, but not limited to, a spherical mirror or an aspherical mirror. Compared with the prior art, the lens module generally includes more than nine sets of lenses. The lens module 10 of the present invention may only include a single lens to realize the functions in the prior art, so as to reduce the required cost and the size of the image capturing system 1 and meanwhile ensure the image quality.

Further, the image sensing element 12 has a receiving surface 120 for receiving the light of the object 5 to form an image 50. In practical applications, the image sensing element 12 is, but not limited to, a charge-coupled device (CCD) or a complementary metal-oxide-semiconductor (CMOS).

The CCD element and the CMOS element are currently two major types of image sensing elements. The CCD sensing element is characterized in that the image signal is fully ensured to be undistorted during transmission and integrality of data can be kept by gathering each pixel to a single amplifier for subsequent unified processing. For the CMOS sensing element, the MOS process commonly used in the semiconductor industry can be applied, in which all peripheral elements are integrated onto a single chip at a time, so as to save the required cost of processing the chip and reduce the loss of yield. Therefore, although the CCD image sensing element is better than the CMOS element in the image quality, the CMOS element is popular to the manufacturers due to the characteristics of low cost, low power consumption, and high integration. Also, as the fabrication technology of the CMOS element is continuously improved and updated, the difference between the CCD and the CMOS gradually decreases.

Furthermore, the adjustment element 14 is connected to the image sensing element 12 and used for adjusting a curvature value of the receiving surface 120, so that the receiving surface 120 matches the imaging surface.

In practical applications, the adjustment element 14 may be an electrowetting element. The electrowetting technology exists in the prior art and is commonly applied to technologies such as optical filters, optical fibers, adjustable lenses, lab chips, and curtain coating. The electrowetting effect is to adjust a wetting characteristic of hydrophobic and hydrophilic statuses among the material systems through an external voltage. Therefore, in this embodiment, the adjustment element 14 has a dielectric layer structure, which includes a polar liquid. When no voltage is applied to the adjustment element 14, the polar liquid presents a contraction status on a hydrophobic dielectric surface, so as to minimize a free energy thereof. When an external voltage is applied to the adjustment element 14, charge distribution occurs on the dielectric layer and the charge distribution attracts affinity of the polar liquid, so that the adjustment element 14 is enabled to control the curvature of the image sensing element 12. Therefore, in this embodiment, the control of variability of the curvature of the image sensing element 12 depends on a magnitude of the external voltage applied on the adjustment element 14.

In addition, the adjustment element 14 may also be a piezoelectric element. The piezoelectric material has various types, such as a single crystal material, a polymer material, a film material, a ceramic material, and a composite material. The ceramic piezoelectric material is currently a major piezoelectric material due to advantages such as capability of being made into a random shape, easy process, high temperature endurance, acid and alkali endurance, good piezoelectric activity, and high coupling factors. Generally, an effect of generating a voltage due to volume changes of the material is referred to as a “direct piezoelectric effect”; while a phenomenon that a volume of the material is changed when the material is stimulated by the applied voltage is referred to as an “inverse piezoelectric effect”. The effect is usually reversible and the material having the characteristic is referred to as the piezoelectric material. The adjustment element 14 of the invention utilizes the characteristic of the piezoelectric material and adjusts the curvature value of the image sensing element 12 by changing the volume of the piezoelectric material through the external voltage.

In this embodiment, the image capturing system 1 further includes a substrate 16, a processing module 18, and a storage module 19. The substrate 16 is used for carrying the image sensing element 12 and the adjustment element 14. In practical applications, the substrate 16 is a flexible substrate. The flexible substrate is formed of, but not limited to, a polymer material or a plastic material.

Further, the processing module 18 is connected to the image sensing element 12 and used for converting the image 50 into a telecommunication signal. The storage module 19 is connected to the processing module 18 and used for storing the telecommunication signal.

In practical applications, the processing module 18 is further connected to the adjustment element 14. The processing module 18 generates a control signal to the adjustment element 14 according to an imaging feature of the image 50, so as to drive the adjustment element 14 to adjust the curvature value of the receiving surface 120.

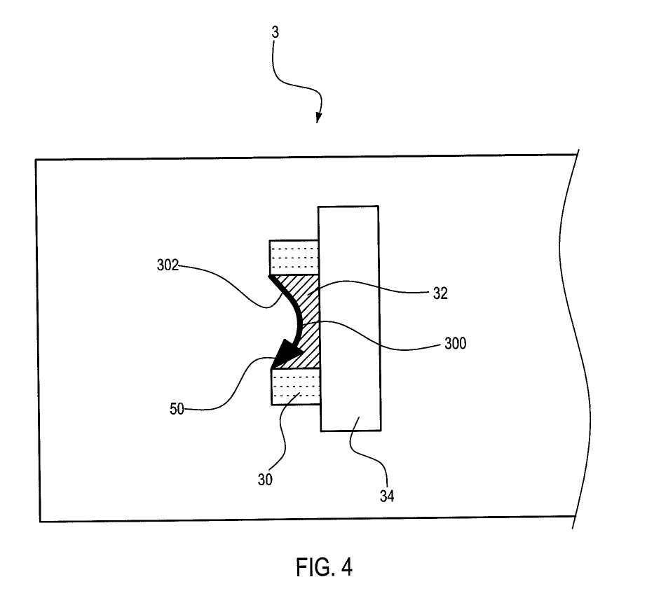

FIG. 4 is a schematic view of a sensing module 3 according to an embodiment of the invention. The sensing module 3 is used for forming an image in cooperation with the above mentioned lens module. The lens module converges light of an object to an imaging surface 302.

As shown in FIG. 4, the sensing module 3 includes an image sensing element 30, an adjustment element 32, and a substrate 34. The image sensing element 30 has a receiving surface 300 for receiving the light of the object to form the image. The adjustment element 32 is connected to the image sensing element 30 and used for adjusting a curvature value of the receiving surface 300, so that the receiving surface 300 matches the imaging surface.

Further, the substrate 34 is used for carrying the image sensing element 30 and the adjustment element 32. In practical applications, as the curvature of the image sensing element 30 is adjustable and the material thereof is usually a flexible material, the substrate 34 is a flexible substrate, which is formed of, but not limited to, a polymer material, a plastic material or other suitable flexible materials.

In conclusion, the image capturing system and the sensing module of the invention utilize an adjustment element to adjust the curvature value of the image sensing element, so as to solve the problem of curvature of field of a common camera. In the prior art, in order to reduce the curvature of field, a set of lens modules having a large number of lenses needs to be used to correct an imaging surface into a plane or an image sensing element having a fixed curvature is used to reduce the curvature of field. Compared with the prior art, the image capturing system and the sensing module of the present invention only need to adjust the curvature value of the image sensing element by using the adjustment element, so that the image sensing element matches a nonplanar imaging surface of a single lens.

Therefore, the image capturing system and the sensing module of the present invention can effectively solve the problem of curvature of field in commercially available digital cameras. Moreover, compared with fabrication of a lens module of high cost, the image capturing system and the sensing module of the present invention have relatively low cost, and thus have great industrial application potential in the market of the image sensing system.

The above detailed description of the preferred embodiments is intended to illustrate the features and spirits of the present invention more clearly, instead of limiting the scope of the invention, and also intended to cover various modifications and equivalent changes within the appended claims of the invention. Therefore, the scope of the appended claims of the invention should be construed in the broadest sense according to the above description, so as to cover all possible modifications and equivalent changes.

What is claimed is:

1. An image capturing system, comprising:
a lens module, for converging light of an object to an imaging surface;
an image sensing element, having a receiving surface for receiving the light of the object to form an image; and
an adjustment element, connected to the image sensing element, for adjusting a curvature value of the receiving surface, so that the receiving surface matches the imaging surface.

2. The image capturing system according to claim 1, further comprising:
a substrate, for carrying the image sensing element and the adjustment element.

3. The image capturing system according to claim 2, wherein the substrate is a flexible substrate.

4. The image capturing system according to claim 3, wherein the flexible substrate is formed of a polymer material.

5. The image capturing system according to claim 3, wherein the flexible substrate is formed of a plastic material.

6. The image capturing system according to claim 1, further comprising:
a processing module, connected to the image sensing element, for converting the image into a telecommunication signal; and
a storage module, connected to the processing module, for storing the telecommunication signal.

7. The image capturing system according to claim 6, wherein the processing module is further connected to the adjustment element, and generates a control signal to the adjustment element according to an imaging feature of the image, so as to drive the adjustment element to adjust the curvature value of the receiving surface.

8. The image capturing system according to claim 1, wherein the lens module comprises at least a lens.

9. The image capturing system according to claim 8, wherein the lens is a spherical mirror or an aspherical mirror.

10. The image capturing system according to claim 1, wherein the image sensing element is a charge-coupled device (CCD) or a complementary metal-oxide-semiconductor (CMOS).

11. The image capturing system according to claim 1, wherein the adjustment element is an electrowetting element.

12. The image capturing system according to claim 1, wherein the adjustment element is a piezoelectric element.

13. A sensing module, for forming an image in cooperation with a lens module that converges light of an object to an imaging surface, comprising:
an image sensing element, having a receiving surface for receiving the light of the object to form the image; and
an adjustment element, connected to the image sensing element, for adjusting a curvature value of the receiving surface, so that the receiving surface matches the imaging surface.

14. The sensing module according to claim 13, further comprising:
a substrate, for carrying the image sensing element and the adjustment element.

15. The sensing module according to claim 14, wherein the substrate is a flexible substrate.

16. The sensing module according to claim 15, wherein the flexible substrate is formed of a polymer material.

17. The sensing module according to claim 15, wherein the flexible substrate is formed of a plastic material.

18. The sensing module according to claim 13, wherein the image sensing element is a charge-coupled device (CCD) or a complementary metal-oxide-semiconductor (CMOS).

19. The sensing module according to claim 13, wherein the adjustment element is an electrowetting element.

20. The sensing module according to claim 13, wherein the adjustment element is a piezoelectric element.
